(19) United States
(12) Patent Application Publication
(10) Pub. No.: US 2011/0223974 A1
(43) Pub. Date: Sep. 15, 2011

(54) MOBILE COMMUNICATION DEVICE AND METHOD FOR OPERATING A MOBILE COMMUNICATION DEVICE

(75) Inventors: Markus AGEVIK, Malmo (SE); Andreas MORTIN, Malmo (SE)

(73) Assignee: SONY ERICSSON MOBILE COMMUNICATIONS AB, Lund (SE)

(21) Appl. No.: 12/752,174

(22) Filed: Apr. 1, 2010

Related U.S. Application Data
(60) Provisional application No. 61/312,295, filed on Mar. 10, 2010.

(51) Int. Cl. H04B 1/38; H04M 1/00; G06F 3/041

(52) U.S. Cl. 455/566; 455/550.1; 345/173

(57) ABSTRACT

The present invention relates to a mobile communication device and a method for operating a mobile communication device to activate or deactivate a function of the mobile communication device automatically. The mobile communication device comprises a user interface operable to receive an input of a user; an acceleration sensing section operable to sense an acceleration motion of said mobile communication device; and a controller adapted to obtain samples of a signal associated with said acceleration motion of said mobile communication device sensed by said acceleration sensing section, which samples constitute a time dependent acceleration pattern, wherein said controller is further adapted to activate or deactivate at least one function of said mobile communication device based on said time dependent acceleration pattern.

### FIELD OF THE INVENTION

The present invention relates to a mobile communication device and a method for operating a mobile communication device. In particular, the mobile communication device comprises a user interface, an acceleration sensing section and a controller that can activate or deactivate a function of the mobile communication device.

### BACKGROUND

Today's mobile communication devices comprise various functions not necessarily limited to receive and place a telephone call. Some mobile communication devices, such as smart phones, provide even functions, such as playing music, taking pictures or providing navigation information or surfing the web.

With an increase in the number of functions of a mobile communication device, such as a cellular phone, or other type of mobile phone, there is also a need for controlling these functions which leads to more and more complex user interfaces. Currently, for example, a large amount of handsets, i.e. mobile phones, are controlled through touch screens, which are sensitive to a finger or a stylus placed on their surface, wherein different functions corresponding to different icons displayed on the touch screen can be selected by a user.

Further, with the increase in complexity of applications running on smart phones also navigation through the menus for control of these applications increases in complexity.

Manually locking a physical keypad or a touch screen or similar constituting a user interface commonly requires to press a combination of two different keys or icons, respectively so that a function of the mobile communication device is not accidentally triggered. Similarly, unlocking may also require pressing two keys or icons.

Further, there are situations in which a function is accidentally deactivated. For example, the function of receiving and accepting an incoming call may be carried out and suddenly it may be deactivated, because another function is activated by the user accidentally pressing a key or an icon on the user interface, which is currently unlocked. In this situation, hanging up could be considered as rude by the caller, for example. In other situations, random calls from the pocket of the user may be triggered which is also unwanted. On the other hand, there several situations in which the mobile phone is locked when the user actually wants to interact with it so that there is large interest in improving handling of the keylock.

Similar to the keylock, switching on and off the backlight of a user interface, such as a touch screen or a keypad has to be controlled adequately so as to avoid wasting power which may be a limiting factor in the operation of a mobile phone. Therefore, it is desirable to provide an improved mobile communication device and method therefor supporting the user of a mobile communication device in the operation thereof.

### DISCLOSURE OF INVENTION

A novel mobile communication device and method for operating the mobile communication device are presented in the independent claims. Advantageous embodiments are defined in the dependent claims.

An embodiment of the invention provides a mobile communication device comprising a user interface operable to receive an input of a user and an acceleration sensing section operable to sense an acceleration motion of the mobile communication device. Further, the mobile communication device comprises a controller adapted to obtain samples of a signal associated with the acceleration motion of the mobile communication device sensed by the acceleration sensing section, wherein the samples constitute a time-dependent acceleration pattern. The controller is further adapted to activate or deactivate at least one function of the mobile communication device, e.g. a function of the user interface, based on the time-dependent acceleration pattern.

Accordingly, a function of the mobile communication device can be activated or deactivated without the user having to press a button or an icon. Therefore, the operation of the mobile communication device is simplified. For example, when a mobile phone is ringing indicating an incoming call, the acceleration sensing section senses an acceleration motion, such as the acceleration motion owing to the user picking up the mobile telephone from a table and moving it to his/her ear. Such a movement will have a distinct time-dependent acceleration pattern which the controller may distinguish from other time-dependent acceleration patterns.

In one embodiment, the controller is adapted to receive the signal associated with the acceleration motion from the acceleration sensing section and adapted to determine a type of acceleration motion using the time-dependent acceleration pattern. Accordingly, the mobile communication device is able to distinguish different types of acceleration motion which may be associated to the activation or deactivation of different functions.

In one embodiment, the acceleration sensing section is adapted to sense at least two different directional components of said acceleration motion and the controller is adapted to receive a first and a second signal associated with the at least two different directional components, respectively. For example, the acceleration sensing section may comprise a first and a second acceleration sensing unit sensitive to two different directions, such as linear directions, angular directions or a combination thereof. Accordingly, more detailed information regarding the acceleration motion of the mobile communication device can be obtained.

In one embodiment, the controller is adapted to determine a type of acceleration motion using a time-dependent acceleration pattern of the first signal and a time-dependent acceleration pattern of the second signal. Accordingly, the type of acceleration motion can be distinguished more accurately increasing the number of functions that may be activated or deactivated, which may be distinguished by an associated type of acceleration motion.

In one embodiment, the controller is adapted to activate the acceleration sensing section for sensing, in response to a specific input to the user interface or in response to the mobile communication device receiving an incoming call or message. Accordingly, an incoming call or message may trigger activation of the acceleration sensing section so as to enable sensing of an acceleration motion. For example, once the acceleration sensing section is activated, it may be checked whether a user picks up the mobile communication device. In response to picking up the mobile communication device, it is then possible to activate the “accept call” or “open message” function automatically without any further user interaction with the user interface.

In one embodiment, the controller is adapted to activate or deactivate the at least one function of the mobile communication device based on the time-dependent acceleration pattern of the at least one signal in response to a specific input to the user interface or in response to the mobile communication device receiving an incoming call or message. Accordingly, once an incoming call or message is received, the call may be accepted or a message may be opened automatically based on the time-dependent acceleration pattern, for example indicating that the user takes the mobile communication device in his/her hand in order to answer the call or read the message. Therefore, there is no need for the user to further interact with the user interface to accept the call or read the message, since the operations usually necessary to accept a call or read a message are automatically triggered by the controller obtaining samples of a signal associated with the acceleration motion.

In one embodiment, the controller is adapted to determine a type of acceleration motion by comparing the time-dependent acceleration pattern with a reference pattern. Preferably, at least one function to be activated or deactivated is dependent on the type of acceleration motion and thus the obtained time-dependent acceleration pattern. Accordingly, reference patterns associated with activation or deactivation of different functions may be stored in the mobile communication device or downloaded from a server and compared to obtained time-dependent acceleration patterns.

In one embodiment, a timing section may be provided in the mobile communication device to provide a time reference. Accordingly, a time resolution of the time-dependent acceleration pattern may be obtained very accurately.

In one embodiment, the mobile communication device may further comprise a display device, wherein the controller is further adapted to turn on or turn off said display device, e.g. the backlight of the display device, based on the time-dependent acceleration pattern. Accordingly, power that is consumed by the display device may be saved.

In one embodiment, the acceleration sensing section comprises at least two of a first linear accelerometer, a second linear accelerometer, a third linear accelerometer, a first gyroscope, a second gyroscope and a third gyroscope. Accordingly, acceleration motion of one or more linear directions, one or more angular directions, or a combination thereof may be obtained.

In one embodiment, the acceleration sensing section comprises three linear accelerometers for sensing acceleration motion in three different linear directions or three gyroscopes for sensing acceleration motion in three different angular directions. Accordingly, a highly accurate representation of the acceleration motion in three-dimensional space may be obtained.

In one embodiment, the user interface comprises a touch screen device. Accordingly, a large variety of functions can be associated with the user interface.

Another embodiment of the invention provides a method for operating a mobile communication device. The method comprises the steps of sensing an acceleration motion of said mobile communication device; obtaining samples of a signal associated with said acceleration motion of said mobile communication device sensed by said acceleration sensing section, which samples constitute a time dependent acceleration pattern, and activating or deactivating at least one function of said mobile communication device based on said time dependent acceleration pattern. Accordingly, a function of the mobile communication device can be activated or deactivated without the user having to press a button or an icon so as to simplify the operation of the mobile communication device.

In another embodiment, the mobile communication device comprises a means for receiving an input of a user; means for sensing an acceleration motion of said mobile communication device; means for obtaining samples of a signal associated with said acceleration motion of said mobile communication device, which samples constitute a time dependent acceleration pattern; and means for activating or deactivating at least one function of said mobile communication device based on said time dependent acceleration pattern.

### BRIEF DESCRIPTION OF THE DRAWINGS

Embodiments of the invention will be described with respect to the following appended figures.

FIG. 1 illustrates a mobile communication device and elements thereof according to an embodiment of the invention.

FIG. 2a illustrates a block diagram of a specific mobile communication device, in particular a mobile phone, according to another embodiment of the invention.

FIG. 2b illustrates an example of an acceleration sensing section of the mobile communication device of FIG. 1 or FIG. 2.

FIG. 2c illustrates different time-dependent acceleration patterns that may be obtained from an acceleration sensing section.

FIG. 3 illustrates a flow diagram of a method for operating a mobile communication device according to an embodiment of the invention.

FIG. 4 illustrates an example of operations of a mobile communication device associated with certain motions.

FIG. 5 illustrates schematically a mobile communication device, in particular a mobile phone, according to another embodiment of the invention.

### DESCRIPTION OF THE EMBODIMENTS

Embodiments of the invention are described with reference to the figures. It is noted that the following description contains examples only and should not be construed as limiting the invention.

In the following, similar or same reference signs indicate similar or same elements.

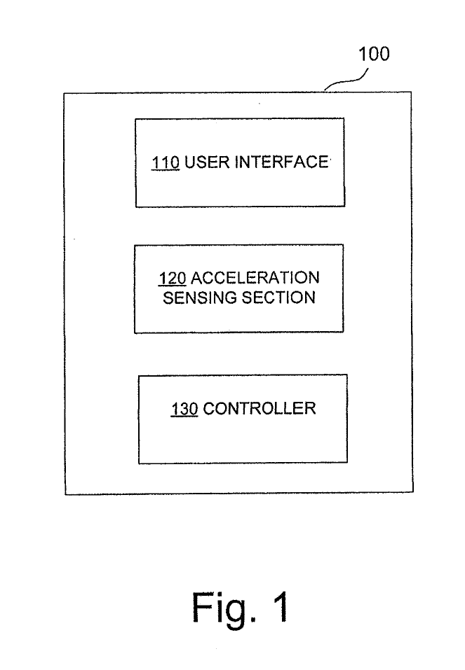

FIG. 1 illustrates elements of a mobile communication device according to an embodiment of the invention. FIG. 1 illustrates the mobile communication device 100 comprising a user interface 110, an acceleration sensing section 120 and a controller 130.

The mobile communication device 100 may be a cellular phone, or other type of mobile phone or also a portable computer. The mobile communication device 100 may also be a headset, such as a Bluetooth headset having communication capabilities.

The user interface 110 in FIG. 1 is a man-machine interface to accept an input of a user and serves as means for receiving a user input operation. In particular, the user interface 110 receives an input of a user to trigger the execution of a function of the mobile communication device, for example in a simple case turning on or off the mobile communication device.

For example, a user interface may be a key or a keypad on a mobile communication device, wherein the key is representative for and triggers a function of accepting an incoming call, for example. Similarly, also a key for terminating an incoming call may be provided.

It is not necessary that the keys are actual physical keys of a keypad or keyboard but a key or a keypad may be simulated by icons displayed on a touch screen, which can be used to trigger functions as a conventional keypad.

The acceleration sensing section 120 is operable to sense an acceleration motion of the mobile communication device 100 and thus serves as means for sensing an acceleration motion. The acceleration sensing section 120 may be any kind of accelerometer which is increasingly being incorporated into personal electronic devices, such as smart phones.

It is noted that an acceleration motion is not limited to how a user and thus a mobile communication device is translated in space but complicated motion patterns may be obtained by tracking the acceleration motion with time, wherein several different kinds of acceleration can be measured depending on the acceleration sensing section used, such as linear/translational acceleration or rotational/angular acceleration. Accordingly, the acceleration sensing section 120 may comprise one, two or three acceleration sensing units, wherein an acceleration sensing unit may be gyroscope sensitive to angular acceleration in an angular direction, such as pitch, roll or yaw, or a linear accelerometer sensitive to linear acceleration in a linear direction, such as x, y or z-axis in a Cartesian coordinate system in three-dimensional space.

The acceleration sensing section 120 of FIG. 1 is operable to convert a sensed acceleration motion to a preferably electric output signal. For example, if the acceleration sensing section 120 only measures acceleration in the linear x-direction, an output signal different from zero can be obtained if the mobile communication device comprising the acceleration sensing section 120 is accelerated or decelerated in the x-direction.

The controller 130 is adapted to obtain samples of the output signal of the acceleration sensing section 120 which is associated with the acceleration motion of the mobile communication device 100 sensed by the acceleration sensing section 120. Here, the controller serves as means for obtaining samples of a signal associated with the acceleration motion and means for activating or deactivating a function based on the time-dependent acceleration pattern. The samples constitute a time-dependent acceleration pattern. For example, the controller obtains a sample at time t₁ and another sample at time t₂ so as to obtain two different signal levels, i.e. amplitudes of the acceleration motion at two different times.

The controller 130 is further adapted to activate or deactivate at least one function of the mobile communication device based on the time-dependent acceleration pattern. A function of the mobile communication device 100 may be a function that is associated with the user interface 110, such as accepting a call or unlocking the user interface 110, i.e. a function that is usually associated with one or more keys or icons that have to be pressed to activate or deactivate the function. In this way, the controller 130 may accept a call automatically without the need for the user to press a key at the user interface 110 so that the acceleration sensing section 120 and the controller 130 trigger a function which is usually associated with the user interface, in other words they substitute at least a part of the user interface in this example.

It is understood that activating a function can be the activation of a function of the user interface, or activate the user interface itself or activate a different function not associated with the user interface, such as activating a ringer. Similarly to accepting a call, the controller 130 may also activate a hang-up function or call termination function to terminate a call. Specific examples will be described further below.

The type of a function that is activated or deactivated is preferably dependent on the type of acceleration motion. Therefore, the controller may be adapted to determine the type of acceleration motion using the time-dependent acceleration pattern. For example, the type of acceleration motion may be an acceleration motion which is associated with a user getting out the mobile communication device of his/her pocket and moving it up to his/her ear. If this type of acceleration motion is detected, the controller can trigger a function to accept the call automatically without the user having to operate the user interface 110.

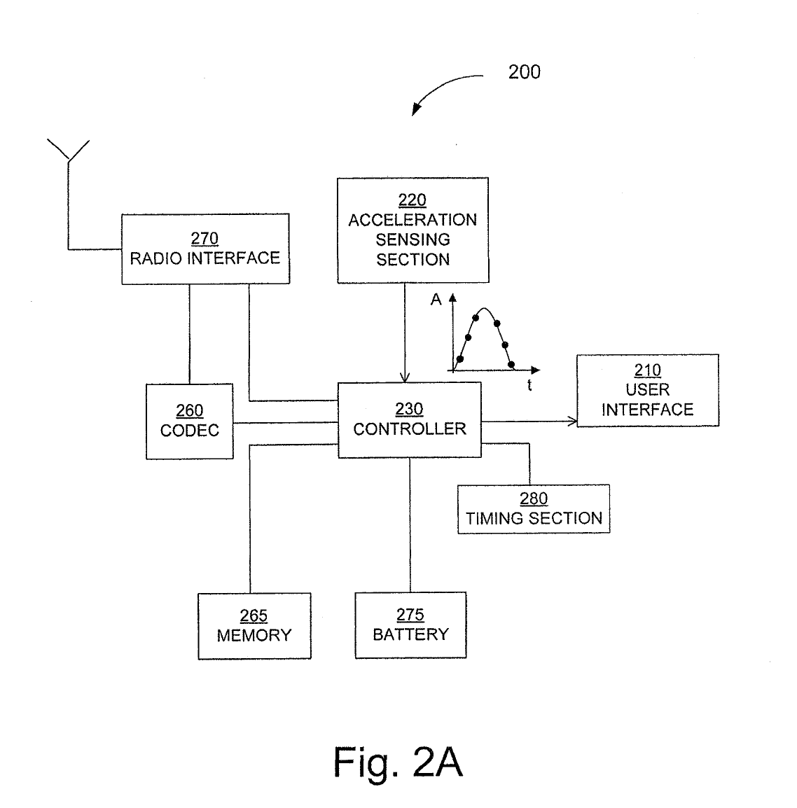

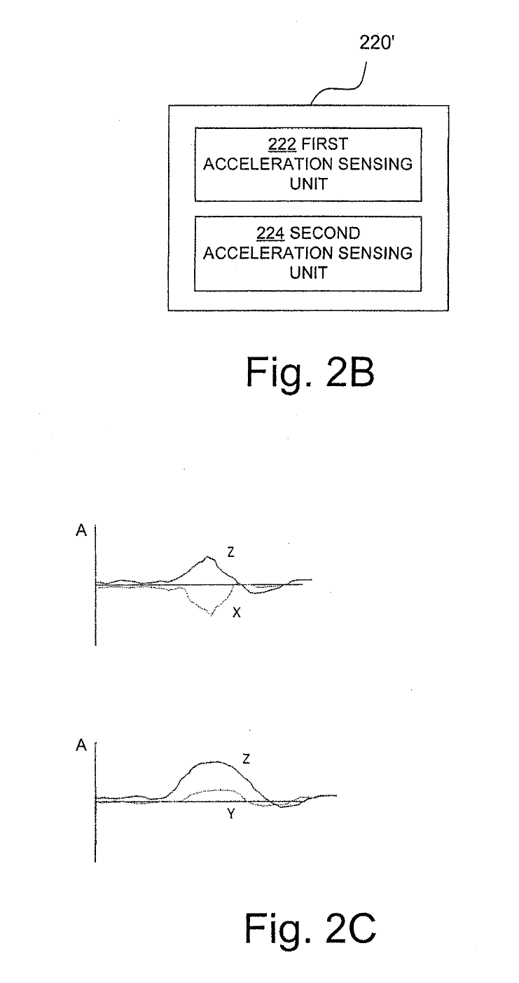

FIG. 2A illustrates a block diagram of a mobile communication device according to another embodiment of the invention. The mobile communication device 200 in FIG. 2A comprises a user interface 210, an acceleration sensing section 220 and a controller 230. Further, the specific example of a mobile communication device shown in FIG. 2A particularly illustrating a mobile phone also comprises a battery 275, a memory 265, a codec 260, a radio interface 270 connected to an antenna and a timing section 280. Radio signals are transmitted and received by the antenna connected through the radio interface 270 to the codec 260 configured to process signals under control of the controller 230. The controller 230 may be a microprocessor-based controller as known in the art of mobile phones to control the elements shown in FIG. 2A.

As described above, also the acceleration sensing section 220 of FIG. 2 senses an acceleration motion and generates an output signal based on the acceleration motion which is transferred to the controller 230 as illustrated in FIG. 2A. The controller 230 obtains samples of the signal at different times to generate a time-dependent acceleration pattern (see dots on the signal waveform). Based on the time-dependent acceleration pattern, the controller 230 may activate or deactivate different functions, such as terminating a call between the mobile communication device 200 and another mobile communication device so that the communication traffic through the codec 260 and radio interface 270 is stopped.

In one example, the acceleration sensing section 220 may comprise a first acceleration sensing unit 222 and a second acceleration sensing unit 224 as shown by the acceleration sensing section 220′ in FIG. 2B. In detail, the acceleration sensing section 220′ is adapted to sense at least two different directional components of the acceleration motion and the controller, such as controller 230, may be adapted to receive a first signal and a second signal associated with the at least two different directional components, respectively. For example, one directional component can be measured by one acceleration sensing unit and may either be one of a linear direction x, y and z or an angular direction, such as pitch, roll and yaw. Accordingly, two different directional components may comprise of a combination of two of linear directions x, y and z and angular directions pitch, roll and yaw.

To analyze these components, the controller 230 may be adapted to determine a type of acceleration motion using a first time-dependent acceleration pattern of the first signal and a second time-dependent acceleration pattern of the second signal.

The acceleration sensing section 220 or 220′ is not limited to the above, and there are several ways of how the acceleration sensing section 220 or 220′ can be realized. The acceleration sensing section 220 or 220′ may comprise at least two of a first linear accelerometer, a second linear accelerometer, a third linear accelerometer, a first gyroscope, a second gyroscope and a third gyroscope. Further, the acceleration sensing section 220 or 220′ may also comprise three accelerometers for sensing acceleration motion in three different linear directions or three gyroscopes for a sensing acceleration motion in three different angular directions. Further, it should be understood that also three acceleration sensing units can be used in FIG. 2B instead of two, which may comprise a combination of linear accelerometers and gyroscopes.

FIG. 2C illustrates examples of a first and a second time dependent acceleration pattern. In the upper graph the time-dependent acceleration pattern sensed in the z-direction and the time-dependent acceleration pattern sensed in the x-direction are shown. This graph shows the output of the acceleration sensing section 220, e.g. acceleration amplitude or force, that is obtained when the communication device is lifted up, e.g. from a table. This is clearly recognized when looking at the time-dependent acceleration pattern of the z-direction. Furthermore, since the time-dependent acceleration pattern of the x-direction is not equal to zero, it can be derived that the communication device is not lifted in a direction parallel to gravity, which can be used to define the z-direction, but with some inclination, i.e. a component perpendicular to gravity.

The lower graph shows the time-dependent acceleration pattern sensed in the z-direction and the time-dependent acceleration pattern sensed in the y-direction, which may be obtained by an acceleration sensing section 220 that is adapted to measure two different directional components, for example using a first acceleration sensing unit and a second acceleration sensing unit, such as units 222 and 224, respectively. In particular, the lower graph shows turning the mobile communication device. For example, the mobile communication device lies flat on a table, is then slightly lifted up and rotated around its x-axis which leads to an acceleration in the y-direction and z-direction as shown in the graph.

In both graphs the output of the acceleration sensing section before the mobile communication device is moved is roughly zero until movement or rotation, respectively, is started.

There are several ways for the controller to determine the type of acceleration motion. For example, reference patterns for lifting the device or turning the device can be stored in the memory 265 and once movement or rotation is detected, the reference patterns may be compared to the time-dependent acceleration patterns. Furthermore, a reference pattern may basically consist of just a couple, at least two threshold values that may be compared to samples of at least one signal associated with the acceleration motion and the determination of the type of the acceleration motion can be performed based on whether the sampled value is above or below a threshold value.

Once the type of the acceleration motion is determined, a function can be activated or deactivated based on the determined type. For example, if it is determined that the mobile communication device is lifted up, a ringing, sound informing of an incoming call may be stopped, since the controller can assume that the user is already aware of the incoming call and lifts up the mobile communication device to answer the call.

To provide a highly accurate time reference for the time-dependent acceleration patterns, the mobile communication device 200 of FIG. 2A may optionally comprise the timing section 280. However, a simple clock signal to sample the signal associated with an acceleration motion at specific intervals is sufficient.

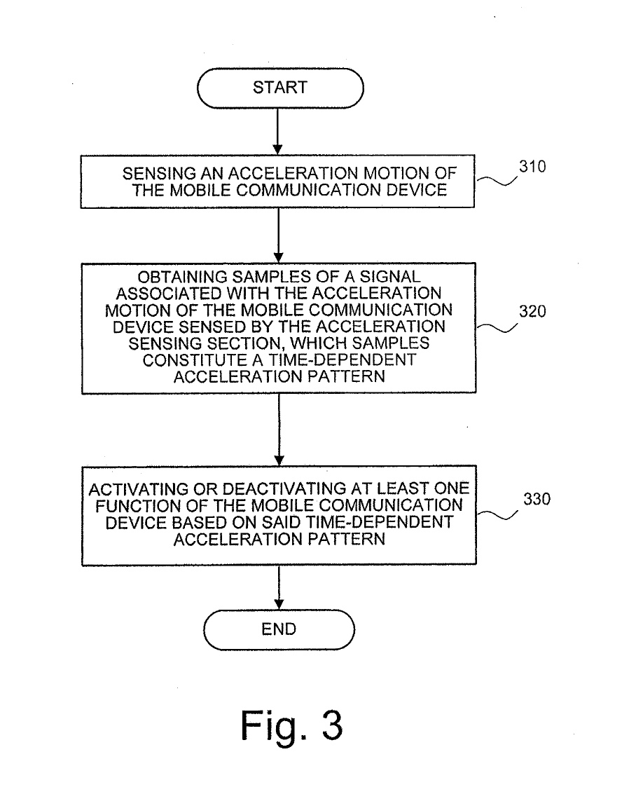

In the following, operations of a method for operating a mobile communication device, such as the mobile communication device 100 or 200, will be described with respect to FIG. 3.

In the first step 310, an acceleration motion of the mobile communication device is sensed. As described above, different acceleration sensing sections may be used for sensing the acceleration motion, wherein the more directional components of the acceleration motion, such as x, y and z-directions or pitch, roll and yaw angular directions are sensed, the more information about the acceleration motion of the mobile communication device can be obtained and thus a more accurate determination regarding the type of motion associated with the type of activation or deactivation can be made.

In the next step 320, samples of the signal associated with the acceleration motion of the mobile communication device are obtained. For example, it is also possible that more than one signal is obtained, wherein the different signals correspond to different linear or angular directions sensed by different units of the acceleration sensing section, as described above. The samples obtained from one signal constitute a time-dependent acceleration pattern indicating the acceleration in a certain direction at different points in time. Examples of time-dependent acceleration patters have been described with respect to FIG. 2C.

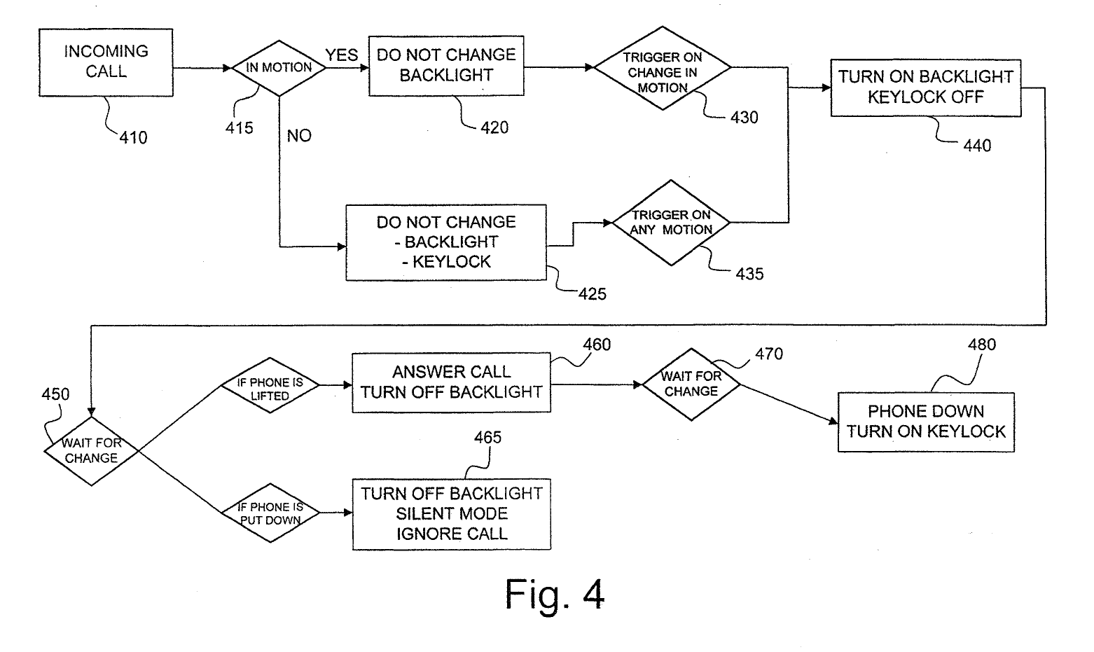

Then, in step 330 a function of the mobile communication device is activated or deactivated based on one or more time-dependent acceleration patterns. For example, a display device of the mobile communication device or the backlight of the display device can be turned on or off according to the one or more time-dependent acceleration patterns, wherein a specific example is described later with respect to FIG. 4.

Turning on or off intelligently the backlight of a display, for example, when the mobile communication device is not in use and acceleration motion is not sensed, may be advantageous in saving battery power of the mobile communication device 100 or 200.

Furthermore, the acceleration sensing section 120 or 220 may also be deactivated to save power, wherein the controller 130 or 230 may be adapted to activate the acceleration sensing section 120 or 220 for sensing, in response to a specific input to the user interface 110 or 210 or in response to the mobile communication device receiving an incoming call or message. Similarly to turning off or on the backlight of a display device of the mobile communication device, which may form a touch screen with the user interface, the controller may be adapted to unlock a locked user interface when a specific acceleration motion is sensed, e.g. an acceleration motion corresponding to a user taking the phone out of his/her pocket and turning the phone towards his/her face. Therefore, the need for pressing a certain key combination to unlock the mobile communication device is removed.

Accordingly, different acceleration motions can be associated to ways how a user interacts with the mobile communication device, i.e. takes it in the hand and moves it in space.

For example, when a mobile phone starts ringing, the user picks up the mobile phone and looks at the screen to see the number or name of the caller. When this motion is translated into technical terms, an acceleration with a certain duration T1 and small yaw and roll motion but clear and distinct pitch motion (turning the phone towards the face) can be sensed by an acceleration sensing section adapted to sense three angular directions. Accordingly, when such an acceleration with such a duration, i.e. three specific time-dependent acceleration patterns for the three different angular directions, is sensed, the controller may turn on the backlight of the mobile phone so that the user can read the number or name of the caller.

Commonly the user would then press the answer key and lift the phone to the ear. This could be detected using technical means by again measuring the acceleration and duration thereof. Such a movement of the mobile phone would correspond to an acceleration with duration T2 and a distinct yaw, pitch and roll motion as the mobile phone is tilted towards the ear. According to this acceleration motion, the call can be answered, i.e. the controller activates the call answer function automatically, as the mobile phone is raised and tilted towards the ear, which eliminates the need for the user to press the answer key. Further, backlight can be turned off to save power, since the user is not anymore looking at the display.

As described above, acceleration motions can be used to obtain time-dependent acceleration patterns for different linear or angular accelerations with different durations to determine the type of acceleration motion, wherein different linear accelerometers or gyroscope as well as a timing section or timer can be utilized for detection. From the above it should be understood that not only the actual force of the acceleration is used, as in commonly known accelerometer applications, but the force over time is tracked and analyzed to detect proper motion. Accordingly, a user's standard behavior, which is quite predictable, can be used to trigger the activation or deactivation of certain functions. For example, when a user receives a call, he/she usually performs the same motions.

It is understood that the acceleration sensing section does not have to be placed necessarily in the housing of a mobile phone but can also be included in a headset. Similar to the above, as the headset is lifted when there is an incoming call, it is possible to detect a characteristic acceleration motion and derive one or more time-dependent acceleration patterns of the headset being put into the ear.

As discussed above, the mobile communication device 100 may also be a headset, such as a Bluetooth headset having communication capabilities. Further, the mobile communication device is not limited to a single tangible unit encompassing all elements in one housing. For example, the elements of the mobile communication device may also be distributed between a headset unit and another portable base unit together so as to form a mobile communication device, i.e. a system of more than one unit. Accordingly, a mobile communication device may be made up of one or more peripheral units comprising the elements of the mobile communication device 100 described above. The peripheral units, such as microphone, headset or user interface may be connected to each other or to the base unit by wire or wirelessly, e.g. Bluetooth. For example, the acceleration sensing section may be included in a headset, and once a call is received, it is sensed that the user moves the headset to his/her ear. Similarly, the acceleration sensing section may be incorporated in a unit, e.g. the base unit, which includes also the user interface, e.g. a touch screen.

The headset unit may be attached to the one or two ears and the portable base unit may be carried at a belt or in a pocket of the user. In such a case, the headset unit may comprise the acceleration sensing section 120 and the base unit may comprise the user interface 110 and the controller 130. Also the headset unit may be a mobile communication device including the acceleration sensing section and the controller without the user interface. The mobile communication device may be basically any mobile device that can be used for communication between two parties or entities.

In FIG. 4 an example describing operations carried out in a mobile phone according to a specific embodiment of the invention.

In step 410 an incoming call is received at the mobile phone. Then, it is sensed whether the mobile phone is in motion in step 415. If not in motion, the backlight of the display device of the mobile phone remains off and the keys remain locked in step 425. If motion is detected, backlight is not changed in step 420. Here, steps 420 and 425 are the same. However, it is feasible that different functions are assigned thereto.

In step 430, which is performed at a point in time after step 415, it is triggered on a change in motion and in step 435 on any motion, since in step 425 the mobile phone did not move. Then, in step 440, if a change in motion in step 430 or any motion in step 435 has been sensed, the backlight is turned on and the keylock is turned off. For example, the steps 410, 415, 420, 430 and 440 may correspond to the above-described example when the phone starts ringing, the user picks up the phone and looks at the screen to see the name of the caller.

Then in step 450, it is waited for a change in motion, for example, whether the mobile phone is lifted up, e.g. to the ear of the user, or if the mobile phone is again put down, e.g. back in the pocket of the user or back on a table.

Accordingly, if the phone is put down, the backlight is turned off, and the mobile phone is switched into silent mode and the call is ignored, as shown in step 465. However, if the phone is lifted up, the call is answered and the backlight is turned off in step 460. In step 470, the controller again waits for a change in motion, e.g. waits for the user to end the call and put down the mobile phone so as to turn on the keylock in step 480.

Accordingly, battery power can be saved, since backlight is switched off when the user is not looking at the display or interacts with a touch screen device or other user interface. It is particularly important for smart phones with large displays to save power and to increase the battery time. Further, a dedicated hardware keylock button may not be needed since the keylock function is triggered automatically which minimizes the number of keys to be pressed when answering calls.

As shown in FIG. 4, the controller is adapted to activate a function of the mobile communication device based on the time-dependent acceleration pattern of a signal of the acceleration sensing section in response to the mobile communication device receiving an incoming call. However, similarly, the controller may activate or deactivate a function also in response to a specific input to the user interface or in response to receiving a message, such as an SMS or MMS.

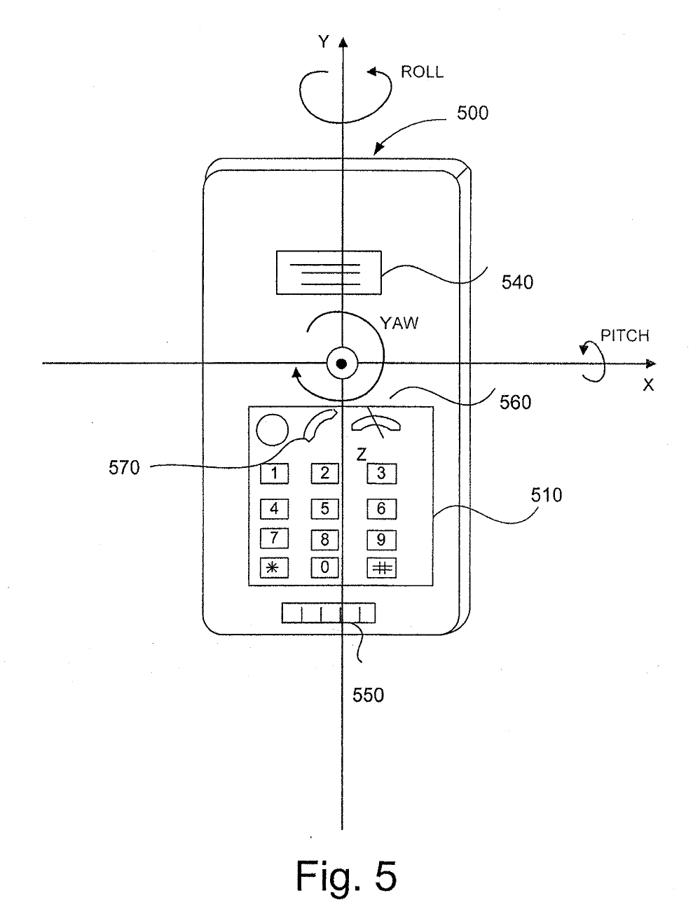

In FIG. 5, a specific example of a mobile communication device according to another embodiment is described, in particular with respect to the arrangement of elements of the mobile communication device and an indication of rotation axes.

The mobile communication device 500 shown is a mobile phone comprising a touch screen device 510 constituting a user interface with displayed icons, such as a call termination icon 560 and a call accept icon 570, a speaker 540 and a microphone 550.

A controller with a processing function, such as the controller 130 or 230 of FIGS. 1 and 2 is not shown but provided inside the housing. This controller may be a central controller or the functions of the controller may be distributed to one or more other controllers, such as a dedicated controller for the acceleration sensing section. It is understood that there are several ways of distributing the functions of the controller between integrated circuits of a mobile communication device, which are all well-known to the skilled person. Similarly, an acceleration sensing section, such as the acceleration sensing section 120 or 220 of FIGS. 1 and 2 is not shown but also provided inside the housing.

As can be seen in FIG. 5, the touch screen device 510, which serves as a user interface, is arranged in close proximity to the speaker 540 so that the risk of accidental termination of a call by pressing on the icon 560 when having the mobile communication device 500 close to the ear or cheek becomes apparent. Therefore, activating the keylock when the user has the mobile communication device at the ear is advantageous.

As shown, the touch screen device 510 comprises several different functions, such as number input functions, which can also be deactivated independent of or in addition to the call termination function so that a beep or other audible signal or even disconnection is avoided when accidentally pressing one of these icons. Furthermore, as described above, it is possible to automatically activate or deactivate these functions including the call accept function and the call termination function depending on the acceleration motion over time.

The above description has mentioned several individual elements such as the controller 130, 230, the user interface 110, 210, the acceleration sensing section 120, 220, etc., and it should be understood that the invention is not limited to these elements being independent structural units but these elements should be understood as elements comprising different functions. In other words, it is understood by the skilled person that an element in the above-described embodiments should not be construed as being limited to a separate tangible part but is understood as a kind of functional entity so that several functions may also be provided in one tangible entity or even where an element, such as the controller performs several functions, these functions may be distributed to different parts.

Moreover, physical entities according to the invention and/or its embodiments and examples may comprise storing computer programs including instructions such that, when the computer programs are executed on the physical entities, such as the controller, a processor, CPU or similar, steps, procedures and functions of these elements are carried out according to embodiments of the invention.

For example, specifically programmed software used to be run on a processor, e.g. contained in the controller, to control the above-described functions, such as controlling the user interface and the acceleration sensing section and obtaining samples of a signal as well as activating or deactivating a function of the mobile communication device, etc. The invention also relates to computer programs for carrying out functions of the elements, such as the method steps described with respect to FIG. 2, wherein the computer programs may be stored on the memory 265 connected to, the controller 230.

The above-described elements of the mobile communication devices 100, 200 and 500 may be implemented in hardware, software, field-programmable gate arrays (FPGAs), application-specific integrated circuits (ASICs), firmware or the like or combinations thereof.

It will be appreciated that various modifications and variations can be made in the described elements, mobile communication devices and methods as well as in the construction of this invention without departing from the scope or spirit of the invention. The invention has been described in relation to particular embodiments which are intended in all aspects to be illustrative rather than restrictive. Those skilled in the art will appreciate that many different combinations of hardware, software and firmware are suitable for practising the invention.

Moreover, other implementations of the invention will be apparent to the skilled person from consideration of the specification and practice of the invention disclosed herein. It is intended that the specification and the examples are considered as exemplary only. To this end, it is to be understood that inventive aspects may lie in less than all features of the single foregoing disclosed implementation or configuration. Thus, the true scope and spirit of the invention is indicated by the following claims.

1. Mobile communication device, comprising
a user interface operable to receive an input of a user;
an acceleration sensing section operable to sense an acceleration motion of said mobile communication device; and
a controller adapted to obtain samples of a signal associated with said acceleration motion of said mobile communication device sensed by said acceleration sensing section, which samples constitute a time dependent acceleration pattern, wherein
said controller is further adapted to activate or deactivate at least one function of said mobile communication device based on said time dependent acceleration pattern.

2. Mobile communication device of claim 1, wherein said controller is adapted to receive said signal associated with said acceleration motion from said acceleration sensing section and adapted to determine a type of acceleration motion using said time dependent acceleration pattern.

3. Mobile communication device of claim 1, wherein said acceleration sensing section is adapted to sense at least two different directional components of said acceleration motion and said controller is adapted to receive a first and a second signal associated with said at least two different directional components, respectively.

4. Mobile communication device of claim 3, wherein said controller is adapted to determine a type of acceleration motion using a time dependent acceleration pattern of said first signal and a time dependent acceleration pattern of said second signal.

5. Mobile communication device of claim 1, wherein said controller is adapted to activate said acceleration sensing section for sensing, in response to a specific input to said user interface or in response to said mobile communication device receiving an incoming call or message.

6. Mobile communication device of claim 1, wherein said controller is adapted to activate or deactivate said at least one function of said mobile communication device based on said time dependent acceleration pattern of said at least one signal in response to a specific input to said user interface or in response to said mobile communication device receiving an incoming call or message.

7. Mobile communication device of claim 1, wherein said controller is adapted to determine a type of acceleration motion by comparing said time dependent acceleration pattern with a reference pattern.

8. Mobile communication device of claim 1, wherein said at least one function to be activated or deactivated is dependent on the type of acceleration motion.

9. Mobile communication device of claim 1 further comprising
a timing section operable to provide a time reference.

10. Mobile communication device of claim 1, further comprising a display device, and wherein
said controller is further adapted to turn on or turn off said display device of said mobile communication device based on said time dependent acceleration pattern.

11. Mobile communication device of claim 1, wherein said acceleration sensing section comprises at least two of a first linear accelerometer, a second linear accelerometer, a third linear accelerometer, a first gyroscope, a second gyroscope and a third gyroscope.

12. Mobile communication device of claim 1, wherein said acceleration sensing section comprises three linear accelerometers for sensing acceleration motion in three different linear directions or three gyroscopes for sensing acceleration motion in three different angular directions.

13. Mobile communication device of claim 1, wherein said user interface comprises a touch screen device.

14. Method for operating a mobile communication device, comprising the steps
sensing an acceleration motion of said mobile communication device;
obtaining samples of a signal associated with said acceleration motion of said mobile communication device sensed by said acceleration sensing section, which samples constitute a time dependent acceleration pattern, and
activating or deactivating at least one function of said mobile communication device based on said time dependent acceleration pattern.

15. Mobile communication device, comprising
means for receiving an input of a user;
means for sensing an acceleration motion of said mobile communication device;
means for obtaining samples of a signal associated with said acceleration motion of said mobile communication device, which samples constitute a time dependent acceleration pattern; and
means for activating or deactivating at least one function of said mobile communication device based on said time dependent acceleration pattern.
